(19) United States
(12) Patent Application Publication
(10) Pub. No.: US 2021/0065315 A1
(43) Pub. Date: Mar. 4, 2021

(54) SYSTEMS FOR PROCURING SERVICE CUSTOMERS AND RELATED METHODS

(71) Applicant: NRG ENERGY INC., Princeton, NJ (US)

(72) Inventors: Matthew Calvin Hinson, Houston, TX (US); Justin Abraham Jose, Houston, TX (US); Wendy Shu-Wen Cheung, Sugar Land, TX (US)

(73) Assignee: NRG Energy, Inc., Princeton, NJ (US)

(21) Appl. No.: 16/555,099

(22) Filed: Aug. 29, 2019

(51) Int. Cl. G06Q 50/06; G06Q 20/20; G06Q 20/32

(52) U.S. Cl. CPC G06Q 50/06; G06K 7/1413; G06Q 20/3276; G06Q 20/202

(57) ABSTRACT

Systems, methods, and computer program products for facilitating the procurement of at least one customer for at least one utility service are disclosed. In an aspect, the systems, methods, and computer program products of the present disclosure may be configured to use a convenient way encourage one or more potential customers to sign up to receive at least one utility service at a third party physical location. The potential customer or customers may then be issued a unique identifier, such as a barcode, that may be used to pay cash for the products and/or services at the same third party location at which the customer signs up for the services, thereby increasing the likelihood they will complete the full registration and payment process.

### FIELD OF THE DISCLOSURE

The present disclosure generally relates to customer procurement and more particularly to systems, methods, and computer program products for facilitating the procurement of customers for one or more services.

### BACKGROUND

The statements in this section merely provide background information related to the present disclosure and do not constitute prior art.

Technological advances continue to reform many aspects of our daily lives, including commerce. Virtual and digital payment methods, including credit cards, PayPal® (available from PayPal Holdings, Inc. of San Jose, Calif.), and Apple Pay® (available from Apple Inc., of Cupertino, Calif.) have largely replaced cash and check based transactions. While these electronic payment methods offer advanced speed and convenience, some customers dislike the lack of privacy they entail. This may lead to situations in which customers have difficulty obtaining certain products or services, or to instances in which customers completely refrain from obtaining certain products or services.

Utilities services—such as electricity—are one example of a commodity for which cash payments may be troublesome. While many people willingly use a credit card or similar payment method to purchase utilities, some utility service customers may prefer to pay with cash for various reasons, such as having poor credit ratings or desiring to not provide personal identification information. These cash-based customers may visit one of various locations to do business in person with a utility provider such as a retail electricity provider (REP). Such locations may include retail store build-outs within third party retail stores, airports, or other establishments, as well as stand-alone retail stores operated by the utility service provider. Customers may select one or more service plans at these locations and then sign up to pre-pay for the one or more services with cash by making an initial payment at a separate location to activate an account and “load up” or create a positive balance, which later gets decremented as the one or more services are used. The customer must “reload” or make subsequent payments when the positive balance reaches a specified amount. These payments must generally be made at money service centers within larger retail stores, such as grocery or general stores, or at stand-alone specialized money service centers that accept payments on behalf of the relevant utility service provider.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

In some aspects, a method for procuring at least one customer for at least one utility service is disclosed, wherein the method comprises: receiving, via at least one computing device, at least one coded link; presenting, via the at least one computing device, an offer to sign up for the at least one utility service at a physical location associated with at least one third party; receiving, via the at least one computing device, information about the at least one customer; and generating, via the at least one computing device, a unique identifier for the at least one customer.

In additional aspects, a system is disclosed, wherein the system comprises: a server comprising a microprocessor; one or more computer storage media having stored thereon instructions that facilitate the procurement of at least one customer for at least one utility service when executed by one or more processors of at least one computing device, causing the one or more processors to: receive, via the at least one computing device, at least one coded link; present, via the at least one computing device, an offer to sign up for the at least one utility service at a physical location associated with at least one third party; receive, via the at least one computing device, information about the at least one customer; and generate, via the at least one computing device, a unique identifier for the at least one customer.

In yet other aspects, the at least one interactive display may comprise a kiosk, a computing device, an electronic display, a poster, and/or a cardboard stand-alone display. Each interactive display may be configured within or at a location that is likely to attract the attention of one or more customers who may be in the market for purchasing one or more utility services, such as electricity services, water/sewerage services, gas services, internet services, cable services, etc. Appropriate locations for the at least one interactive display may include, for example, retail stores, grocery stores, pharmacies, shopping malls, convenience stores, fast food restaurants, banks, bus stops, and the like.

In some aspects, an interactive display in accordance with the present disclosure may interact with a customer's mobile computing device by providing a scannable quick response (QR) code or barcode; by communicating via Bluetooth® (a wireless technology standard standardized as IEEE 802.15.1), radio-frequency identification (RFID), and/or near field communication (NFC) technology; and/or by visually displaying an account number, identification (ID) number, website address, or software application name that the customer may manually enter into the mobile computing device.

In some aspects, the method of payment used by the customers using the systems, methods, and computer program products of the present disclosure may comprise a barcode, QR code, or similar scannable patterns or images that a customer may present at a payment location (e.g., a cash register or similar point of sale terminal). Once scanned, the code may establish a link to the customer's utility service account, and the point of service (POS) terminal may then be used to credit the account with an amount equal to a contemporaneously received payment from the customer, which may be in the form of cash, credit card, an Apple Pay® transaction, or any appropriate form.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of an exemplary system for facilitating the procurement of at least one customer for at least one utility service, according to an aspect of the present disclosure.

FIG. 2 is a flowchart illustrating an exemplary process for procuring at least one customer for at least one utility service, according to an aspect of the present disclosure.

FIG. 3 is a flowchart illustrating an exemplary process for procuring at least one customer for at least one utility service and initiating delivery of the at least one utility service to the at least one customer, according to an aspect of the present disclosure.

FIGS. 4A-4C are images of a customer using an exemplary mobile computing device to interact with an exemplary interactive display in order to facilitate cash payment for at least one utility service, according one or more aspects of the present disclosure.

FIGS. 5A-5C are images of various exemplary screenshots that may be presented on a mobile computing device to at least one prospective customer for at least one utility service, according to one or more aspects of the present disclosure.

FIG. 6 is a block diagram of an exemplary computing system useful for implementing one or more aspects of the present disclosure.

### DETAILED DESCRIPTION

Because cash-based customers must visit one or more locations to do business with a utility service provider in person, current processes by which cash-based customers may obtain one or more product and/or service are more costly and cumbersome and is not as efficient as it could be. Because customers must sign up for and pay for desired products and/or services at different locations, there are many instances when a customer agrees to sign up for one or more product and/or service but never completes the payment process and therefore never becomes a customer to the relevant service provider of the products and/or services. This leads to wasted time and money and lost revenue for the service providers who must pay to provide staff and rent space at various locations, as well as wasted time and potential unmet needs for the would-be customer.

Given the foregoing, systems, methods, and computer program products are needed that facilitate a cash-based customer's ability to efficiently pay for one or more product and/or service at the time and place at which the customer signs up to receive the one or more product and/or service.

Aspects of the present disclosure meet the above-identified needs by providing one or more system, method, and computer program product and/or service that facilitates the ability of one or more customer to use cash to pay for one or more product and/or service, such as one or more utility product and/or service, at substantially the same time and place at which the one or more customer agrees to purchase the one or more products and/or service. Specifically, in an aspect, systems, methods, and computer program products are disclosed wherein one or more customer may use a mobile computing device, such as a smartphone, to interact with at least one interactive display within a retail store or similar physical location, whereby such interaction causes the mobile computing device to display at least one digital interactive form. By completing the interactive form, the one or more customer may set up an account for one or more product and/or service with one or more utility service provider and receive at least one method for facilitating payment, including prepaid cash payment.

The present disclosure is directed to one or more system, method, and computer program product that facilitates the procurement of at least one customer of at least one product and/or service as disclosed herein. Specifically, in an aspect, systems, methods, and computer program products are disclosed that use computational instructions, or code, in the form of software and/or one or more software applications that, when executed by one or more computer processors, causes one or more processor to perform certain steps in order to receive information from a prospective customer in order to create an account to receive at least one utility service, generate a unique identifier for the customer, and facilitate payment from the customer for the at least one utility service. In some aspects, the software and/or one or more software applications may further facilitate the initiation of delivery of the at least one utility service to the at least one customer in an at least partially autonomous manner.

The terms “utility” and “utility service” and/or the plural forms of these terms are used herein to refer to one or more product and/or service (both singular and plural) provided by an organization that sells one or more product and/or service as defined in this paragraph to consumers or end users and/or maintains infrastructure for the one or more product and/or service. As used herein, the terms “product” and “service,” both in singular and plural form, include but are not limited to at least the following: electricity; natural gas; water; sewerage; communication systems (including internet/phone/data); cable television; renewable energy credits (aka RECs); and the like. As used herein, an “organization” may be any business or governmental enterprise such as a corporation, partnership, joint venture, agency, military branch, and the like.

The terms “display” and “interactive display” and/or the plural forms of these terms are used herein to refer to any physical and/or electronic object or device such as posters, cardboard stand-alone displays, electronic display screens, computer kiosks, kiosks, computing devices (including a visual display on a computing device), and the like, accessible by a customer. For example, an interactive display may be configured to get the attention of at least one prospective customer for at least one utility service and present information to and/or receive information from the at least one prospective customer. Also, an existing or potential customer may use a display to obtain information regarding a desired service or product.

The term “user” and/or the plural form of this term is used herein to refer to any person. For example, a user may be any individual, corporate entity, and/or agents or affiliates that act on behalf of corporate entities or other third parties. A user may also comprise an automated system that behaves like a user or that performs functions on behalf of one or more user. By way of example and not limitation, a user may be a customer, a potential and/or prospective customer, an agent for a customer or utility service provider, and the like. A customer may be referred to herein as a “customer user” and an agent may be referred to as an “agent user.”

The terms “contemporaneous” and “contemporaneously” are used herein to refer to two or more actions or events that exist, occur, or originate during a same time or a same timeframe. For example, the actions or events may occur at or near the same time, such as within milliseconds, seconds or minutes of each other.

The terms “automatic” and “automatically” are used herein to refer to any action or event that may occur with little or no direct human involvement or input. For example, there may be no human interaction between a step that is automatically performed and the previous step. Human involvement may occur when setting up the automatic action or event even though the action or event itself may occur automatically (e.g., in response to another action or event) after it has been set up.

The terms “a” and “an” refer to one or more of an entity and may be used to refer to either a singular or plural form of the entity being discussed. The terms “or,” “and/or,” “one or more,” and “at least one” are open-ended terms and are conjunctive and disjunctive.

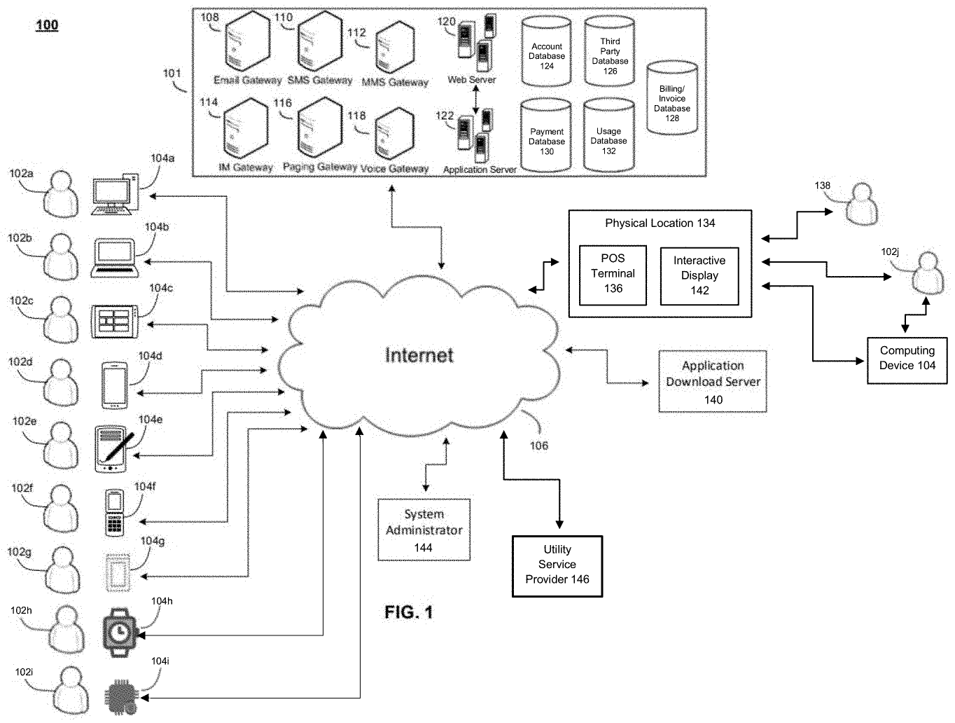

Referring now to FIG. 1, a block diagram of an exemplary system 100 for facilitating the procurement of at least one user 102 for at least one utility service, according to an aspect of the present disclosure, is shown.

Cloud-based, Internet-enabled device communication system 100 may include a plurality of users 102 (shown as users 102a-i in FIG. 1) accessing, via a at least one computing device 104 (shown as respective computing devices 104a-i in FIG. 1) and a network 106, such as the global, public Internet—an application service provider's cloud-based, Internet-enabled infrastructure 101. In some aspects, a user application may be downloaded onto at least one computing device 104 from an application download server 140. Application download server 140 may be a public application store service or a private download service or link. The at least one computing device 104 may access application download server 140 via network 106. In another non-limiting embodiment, infrastructure 101 may be accessed via a website or web application. Multiple users 102 may, simultaneously or at different times, access (via, for example, a user application) infrastructure 101 in order to engage in communication with other users 102 and/or to access account database 124, third party database 126, billing/invoice database 128, payment database 130, usage database 132. System 100 may further comprise at least one interactive display 142 with which at least one user (shown as user 102j in FIG. 1) may engage with directly, with or without a computing device 104. By way of example and not limitation, interactive display 142 may comprise a poster, cardboard stand-alone display, electronic display screen, and/or computer kiosk, kiosks, computing devices, as well as any similar structure or apparatus as may be apparent to those skilled in the relevant arts after reading the description herein.

In some aspects, interactive display 142 may be configured within or near a physical location 134, such as, by way of example and not limitation, a retail store, a grocery store, a pharmacy, a shopping mall, a convenience store, a fast food restaurant, a bank, a bus stop, a community event (such as, by way of example and not limitation, an event at a city park or public beach) or any similar location operated or maintained by at least one third party. In some additional aspects, such as, by way of example and not limitation, when interactive display 142 may take the form of at least one computing device 104, interactive display 142 may be transported and attended to by at least one user 102 in the form of an agent for a product and/or service provider 146. In such aspects, physical location 134 may comprise a more transient or temporary form, such as, by way of example and not limitation, a residential location for one or more potential customer users 102 or any public place, either indoor or outdoor. In any instance, physical location 134 may comprise at least one POS terminal 136 for making financial transactions, such as a cash register, credit card reader, etc. For example, the physical location 134 may be located adjacent to the at least one POS terminal 136, or the at least one POS terminal may be located within the physical location 134. Also, the physical location 134 and the at least one POS terminal 136 may be associated in any way, for example by having the common or related ownership interests, or by being maintained by the same or related entities. The financial transactions of the at least one POS terminal 136 may be performed or monitored by at least one third party representative 138 (e.g., a cashier). In some additional non-limiting exemplary embodiments, one or more interactive displays 142 may be configured remotely from at least one POS terminal 136, such that interactive displays 142 and at least one POS terminal may be any distance apart, such as separated by thousands of meters or one or more kilometers. In some additional aspects, a single interactive display 142 may be used to facilitate payment at multiple POS terminals 136 and/or a single POS terminal 136 may be configured to accept payments facilitated by multiple interactive displays 142.

In various aspects, the at least one computing device 104 may comprise any type of known computing device or collection of computing devices. Examples of the at least one computing device 104 include a desktop computer 104a, a laptop computer 104b, a tablet or mobile computer 104c, a smartphone (alternatively referred to as a mobile device) 104d, a Personal Digital Assistant (PDA) 104e, a mobile phone 104f, a handheld scanner 104g, a smart wearable device 104h, a voice enabled device 104i, any commercially-available intelligent communications device, or the like. In general, computing device 104 may provide many capabilities to one or more users 102 who desire to interact with interactive display 142.

As shown in FIG. 1, in an aspect of the present disclosure, an application service provider's cloud-based, communications infrastructure 101 may include an email gateway 108, an SMS (Short Message Service) gateway 110, an MMS (Multimedia Messaging Service) gateway 112, an Instant Message (IM) gateway 114, a paging gateway 116, a voice gateway 118, one or more web servers 120, one or more application servers 122, an account database 124, a third party database 126, a billing/invoice database 128 a payment database 130, and a usage database 132. One or more application servers 122 may contain computational instructions, or code, that enables the functionality of system 100. Account database 124, third party database 126, billing/invoice database 128, payment database 130, and/or usage database 132 may not necessarily be contained within infrastructure 101; for instance, by way of example and not limitation, account database 124, third party database 126, billing/invoice database 128, payment database 130, and/or usage database 132 may be supplied and/or hosted by a third party. As will be appreciated by those skilled in the relevant arts after reading the description herein, communications infrastructure 101 may include one or more additional storage, communications, and/or processing components to facilitate communication within system 100, process data, store content, and the like. In some non-limiting exemplary embodiments, one or more web servers 120 may be replaced simply by one or more application programming interface (API) endpoints, automated bots, or the like.

A “database” as used herein is an organized collection of data held in a computer. The data may be organized to model components of reality in a way that supports processing for the information associated with the components. The database design may be any organizational schema or model of the data, the database type may be any type, and the database may interact with any type of database management system. Although various data and data structures are described herein as being stored on certain databases, the data and data structures may be organized and stored differently without departing from the scope of this disclosure. For example, data from multiple databases may be stored on a single database or data may be further split up and stored within additional databases. In addition, the databases may be hosted and managed by any entities or combination of entities.

Account database 124 may be configured to store account information for at least one utility service customer. Account information that may be stored within account database 124 may include, by way of example and not limitation, account numbers for one or more utility service customers, service addresses for one or more utility service customers, service start dates for one or more utility service customers, phone numbers and/or email addresses for one or more utility service customers, names and/or birthdates for one or more utility service customers, meter numbers for one or more locations receiving one or more utility services, and the like.

Third party database 126 may be configured to store and/or transmit information (e.g., to sign up a new customer for one or more product and/or service), process payments (e.g., to set up one or more product and/or service), or the like, pertaining to at least one third party that may own, operate, maintain, and/or otherwise be associated with at least one physical location 134 and one or more POS terminals 136 that may be associated therewith. Third party information that may be stored within third party database 126 may include, by way of example and not limitation, the name of the third party (e.g., Target®, Walmart®, McDonalds®, etc.) associated with a particular physical location 134, identification information for the third party associated with a particular physical location 134 (e.g., address, location type (e.g., retail store, grocery store, fast food restaurant, bank, bus stop, individual sales person, etc.), registration number etc.), the commission rate, if any, charged by the third party for sales or assistance with sales and/or setup and/or management of one or more product and/or service on behalf of a product and/or service provider 146, and the like.

Billing/invoice database 128 may be configured to store billing and/or invoice information for at least one customer of at least one utility service. Billing/invoice information that may be stored within billing/invoice database 128 may include, by way of example and not limitation, the date of a particular invoice, the amount a particular customer owes, applicable taxes and fees, a particular customer's average utility service usage rate, and the like.

Payment database 130 may be configured to store payment information for at least one customer of at least one utility service. Payment information that may be stored within payment database 130 may include, by way of example and not limitation, the date on which a particular payment was made, the type of payment that was submitted (e.g., cash, 402 (not shown in FIG. 1) check, credit card, Apple Pay®, bitcoin or other cryptocurrency, gift card, NFC, etc.), the physical location 134 at which a particular payment was made (if applicable), the POS terminal 136 used to process a particular payment (if applicable), and the like.

Usage database 132 may be configured to store information pertaining to a particular customer's utility service usage by time (e.g., in the case of electricity, this may be represented by kilowatt hours of energy used and/or generated per month), a particular customer's utility service usage rate, and the like.

Account database 124, third party database 126, billing/invoice database 128, payment database 130, and usage database 132 may be physically separate from one another, logically separate, or physically or logically indistinguishable from some or all other databases.

In some aspects, a system administrator 144 may access infrastructure 101 via the Internet 106 in order to oversee and manage infrastructure 101.

In some aspects, one or more users 102, such as one or more prospective customer of at least one utility product and/or service, may use at least one computing device 104, such as, by way of example and not limitation, a smartphone, in order to engage in direct communication with an interactive display 142. In some additional aspects, one or more user 102 may engage with interactive display 142 directly. Whether interaction occurs via one or more computing devices 104 or is direct with interactive display 142, such interaction may comprise the use of various technologies, including but not limited to dynamic artificial intelligence (AI) interaction technologies, such as voice enabled services; push/active/proximity based technologies, such as beacons, near field communication (NFC), Wi-Fi, Bluetooth® (a wireless technology standard standardized as IEEE 802.15.1), RFID, and the like; and manual interaction technologies wherein one or more user 102 is required to make the first effort to initiate an interaction, such as by scanning a barcode, QR code, or SnapCode, entering a website URL, clicking a link, and/or taking one or more similar actions to engage system 100. AI interaction technologies may include all AI provider services, including but not limited to voice, video, image, brain wave, and visual processor/provider services.

As will be appreciated by those skilled in the relevant arts after reading the description herein, an application service provider—and individual person, business, or other entity—may allow access, on a free registration, paid subscriber, and/or pay-per-use basis, to infrastructure 101 via one or more World-Wide Web (WWW) sites on the Internet 106. Thus, system 100 is scalable.

As will also be appreciated by those skilled in the relevant arts, in an aspect, various screens may be generated by one or more server 120 in response to input from one or more user 102 over Internet 106. As a non-limiting example, the one or more server 120 may comprise a typical web server running a server application at a website that sends out webpages in response to Hypertext Transfer Protocol (HTTP) or Hypertext Transfer Protocol Secured (HTTPS) requests from remote browsers on various computing devices 104 being used by one or more user 102. Thus, the one or more server 120 is able to provide a graphical user interface (GUI) to one or more user 102 that utilize system 100 in the form of webpages. These webpages are sent to the one or more user's 102 PC, laptop, mobile device, PDA, or like computing device 104, and would result in the GUI being displayed.

As will be appreciated by those skilled in the relevant arts after reading the description herein, alternate aspects of the present disclosure may include providing a tool for facilitating the procurement of at least one customer for at least one utility service via at least one computing device 104 as a stand-alone system (e.g., installed on one server PC) or as an enterprise system wherein all the components of system 100 are connected and communicate via an inter-corporate Wide Area Network (WAN) or Local Area Network (LAN). For example, in an aspect where one or more users 102 are all personnel/employees of the same company or are all members of the same group, the present disclosure may be implemented as a stand-alone system, rather than as a web service (i.e., Application Service Provider (ASP) model utilized by various unassociated/unaffiliated users) as shown in FIG. 1. This may occur, by way of example and not limitation, in aspects wherein at least one computing device 104 attended to by one or more agent user 102 may be used to perform the functions that may otherwise be performed by a potential one or more customer user 102, at least one computing device 104, and a POS terminal 136, thereby negating the need for those additional devices and the network they rely on.

As will also be appreciated by those skilled in the relevant arts after reading the description herein, alternate aspects of the present disclosure may include providing the tools for facilitating the procurement of at least one customer of at least one utility service via infrastructure 101 and/or at least one computing device 104 via a browser or operating system pre-installed with an application or a browser or operating system with a separately downloaded application on such at least one computing device 104. That is, as will also be apparent to those skilled in the relevant arts after reading the description herein, the application that facilitates the procurement of at least one customer of at least one utility service may be part of the “standard” browser or operating system that ships with the at least one computing device 104 or may be later added to an existing browser or operating system as part of an “add-on,” “plug-in,” or “app store download.”

Infrastructure 101 may be encrypted to provide for secure communications. A security layer may be included that is configurable using a non-hard-cooled technique selectable by one or more user 102 that may be based on at least one of: one or more user 102; country encryption standards, etc. A type of encryption may include, but is not limited to, protection at least at one communication protocol layer such as the physical hardware layer, communication layer (e.g., radio), data layer, software layer, etc. Encryption may include human interaction and confirmation with built-in and selectable security options, such as, but not limited to, encoding, encrypting, hashing, layering, obscuring, password protecting, obfuscation of data transmission, frequency hopping, and various combinations thereof. As a non-limiting example, the prevention of spoofing and/or eavesdropping may be accomplished by adding two-prong security communication and confirmation using two or more data communication methods (e.g., light and radio) and protocols (e.g., pattern and freq. hopping). Thus, at least one area of security, as provided above, may be applied to at least provide for communication being encrypted while in the cloud; communication with one or more users 102 that may occur via the Internet 106, a Wi-Fi connection, Bluetooth®, satellite, or another communication link; communications between at least one computing device 104 and other computing devices 104; communications between Internet of Things devices and at least one computing devices 104; and the like.

In some aspects, system 100 may include at least one firewall security system representing a multitude of technologies designed to prevent against fraud and cyber-attacks while enforcing other digital security measures. Such firewall system may continuously evolve over time and therefore be ever-changing. The firewall security system may function in tandem with other standard technologies such as switches, routers, and/or load balancers in order to effectively and efficiently support incoming and outgoing traffic from any devices or technologies.

The Internet of Things, also known as IoT, is a network of physical objects or “things” embedded with electronics, software, sensors, and connectivity to enable objects to exchange data with the manufacturer, operator, and/or other connected devices based on the architecture of International Telecommunication Union's Global Standards Initiative. The Internet of Things allows objects to be sensed and controlled remotely across existing network architecture, creating opportunities for more direct integration between the physical world and computer-based systems, and resulting in improved efficiency, accuracy, and economic benefit. Each thing is uniquely identifiable through its embedded computing system but is able to interoperate within the existing Internet architecture. Communications may comprise use of transport layer security (“TLS”), fast simplex link (“FSL”), data distribution service (“DDS”), hardware boot security, device firewall, application security to harden from malicious attacks, self-healing/patching/firmware upgradability, and the like. Security may be further included by using at least one of: obfuscation of data transmission, hashing, cryptography, public key infrastructure (PKI), secured boot access, and the like.

System 100 may further include one or more components and/or technologies configured to enable the execution of one or more additional various services. Such services may include, by way of example and not limitation, authorization and authentication services, billing and payment services, AI services, notification services, automated identification and data capture (AIDC) services, account services, third party services, as well as a variety of “other” services, including location services, document generation services, mobile application services, API services, and the like. All of the components needed to facilitate any of these services may be configured in-house, supplied by a third party, provided via cloud computing, or any combination thereof.

Authentication and authorization services for system 100 may include services and technology dedicated to the tasks of authentication and authorization, such as, for example and not limitation, using lightweight directory access protocol (LDAP) to allow secure access to different parts of system 100.

Billing and payment services for system 100 may include invoice generation services and payment consolidation services, among others. These services may be used in conjunction with the notification services for system 100 in order to help keep the one or more users 102 apprised of current and future utility service charges and/or credits. Regarding cash payments, the billing and payment services may be used in conjunction with the AIDC services, account services, and/or third-party services in order to process payments or fulfill one or more other requests directly from the one or more users 102, third parties, utility service providers, etc.

The AI services of system 100 may comprise a combination of services that mainly serve to give AI voice/video/image providers integration pathways and APIs to various parts of system 100, including to infrastructure 101, in order to enable the providers to expose sets of product and/or service provider 146 services via the providers' technologies.

Notification services for system 100 are important for delivering communications from system 100 to the various one or more users 102 in the form of customers. The notification channels may use familiar and accessible communication channels to send information to and request information from the one or more customer users 102 both proactively and reactively. These communication channels may include, by way of example and not limitation, email services, simple notification services (SNS), and push notifications directly to the one or more customer users 102 software applications.

The AIDC service for system 100 may facilitate the ability of the one or more customer users 102 to make payments, such as cash 402, from any valid payment location. By way of example and not limitation, the AIDC service enables system 100 to generate various AIDC images and/or information that may represent different types of data, including account information for the one or more customer users 102 as well as third party information for a given physical location 134. This data may then be used by physical location 134 to process the payment of the one or more customer users 102 via the payment services by scanning the AIDC information provided by the one or more customer users 102 and the AIDC for the physical location 134, along with other basic payment data.

Account services for system 100 may include services related to one or more accounts for one or more customer users 102. By way of example and not limitation, such services may include account provisioning, account de-provisioning, account status/standing data, account balance data, and the like.

Third party services for system 100 may be utilized by various third parties in order to facilitate smoother transactions during third party signup as well as enhance third party performance, signups by one or more customer user 102, and payments made by the one or more customer user 102, among others. The third party services generally give one or more third parties controlled overall access to system 100 components and services.

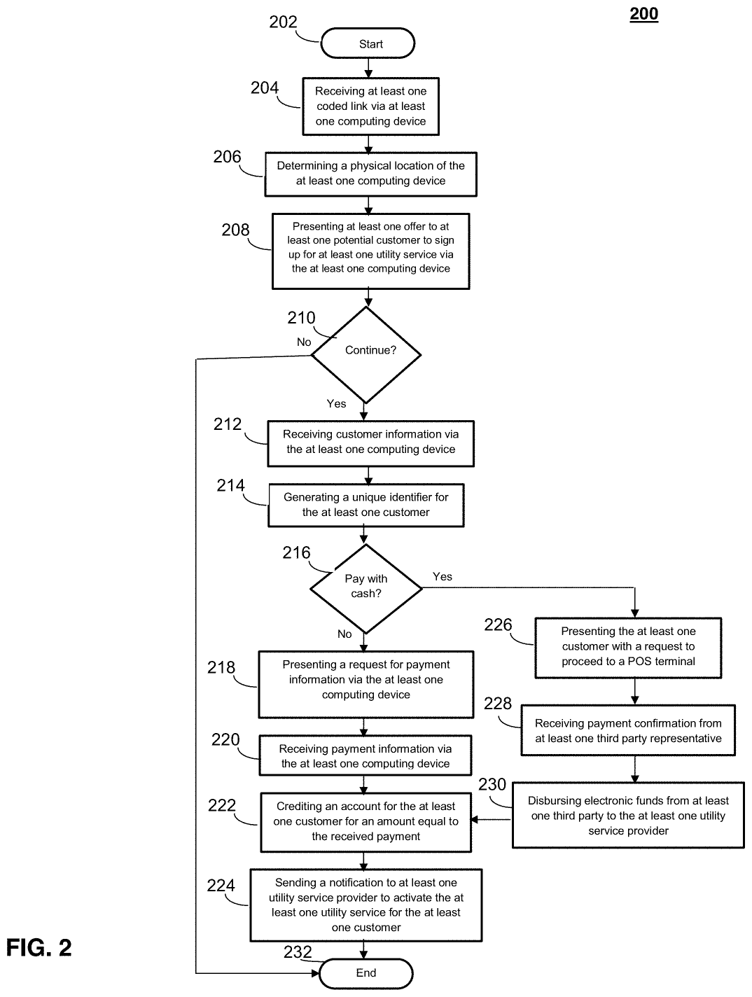

Referring now to FIG. 2, a flowchart illustrating an exemplary process 200 for procuring at least one customer for at least one utility service, according to an aspect of the present disclosure, is shown.

Process 200, which may at least partially execute within system 100 (not shown in FIG. 2), either automatically and/or manually, begins at step 202 with control passing immediately to step 204.

At step 204, at least one coded link 501 (not shown in FIG. 2) is received by at least one user computing device 104 (not shown in FIG. 2). In some aspects, coded link 501 may be provided by at least one interactive display 142 (not shown in FIG. 2), which may be configured at or within at least one physical location 134 (not shown in FIG. 2) that is owned, operated, and/or maintained by at least one third party. By way of example and not limitation, coded link 501 may comprise a QR code, a barcode, a SnapCode, a potential account number, a password, or any similar pictorial and/or textual content as may be apparent to those skilled in the relevant arts after reading the description herein. In some non-limiting exemplary embodiments, coded link 501 may be actively input into at least one computing device 104 by one or more potential customer user 102, such as, for example and not limitation, by scanning coded link 501 with a camera or by manually entering coded link 501 using a touchscreen and a graphical user interface displayed via at least one computing device 104 and/or interactive display 142. In some additional non-limiting exemplary embodiments, coded link 501 may be automatically sent to at least one computing device 104 while requiring only little or no action on the part of the one or more potential customer user 102, such as, for example and not limitation, by being sent via a Wi-Fi signal, via a Bluetooth® connection between interactive display 142 and at least one computing device 104 or by being transmitted via NFC, RFID, or beacon technology in order to obtain the attention of the one or more potential customer user 102 in a more proactive manner. In still some additional aspects, the link may not be coded at all, but rather the one or more potential customer user 102 may actively enter a website address or log into a software application.

At step 206, a physical location is determined for at least one computing device 104 (and also for the one or more potential customer user 102) and/or interactive display 142. In some non-limiting exemplary embodiments, system 100, or any component thereof, may determine the physical location in an at least partially automatic fashion. In some aspects, system 100 may accomplish this by accessing and using location metadata linked to the at least one coded link 501 utilized at step 204. By way of example and not limitation, the metadata may include information regarding the physical location 134 at which the interactive display 142 is located that is being utilized by the one or more potential customer user 102. In some additional aspects, the one or more potential customer user 102 may enter location information manually (such as, for example and not limitation, a zip code for a proposed address at which to receive one or more utility services) by using one or more input devices configured to facilitate human interaction with the at least one computing device 104 and/or interactive display 142, such as a keypad, keyboard, touchscreen, mouse, joystick, microphone, and the like. This information may be used to deliver customized messages, offers, and/or instructions to the one or more potential customer user 102 in order to increase the likelihood of obtaining a response from the one or more potential customer user 102. In yet some additional aspects, location information for the one or more potential customer user 102 may be obtained by getting permission from the one or more potential customer user 102 to access and use the GPS data within at least one computing device 104. As will be appreciated by those skilled in the relevant arts after reading the description herein, other appropriate methods for determining the physical location of at least one computing device 104 and/or interactive display 142 may be used without departing from the scope of the present disclosure.

At step 208, at least one offer is presented to the one or more potential customer user 102 to sign up for at least one utility service via at least one computing device 104 and/or interactive display 142. In some non-limiting exemplary embodiments, the offer may be presented in an at least partially automatic fashion as a response triggered by the physical location determination accomplished by system 100 at step 206. In some aspects, the offer may comprise an offer to sign up for, purchase, and receive at least one utility service form at least one product and/or service provider 146 (not shown in FIG. 2). By way of example and not limitation, the offer may be displayed upon at least one display screen or monitor communicatively connected, either wirelessly or via wired connectivity, to at least one computing device 104 and/or interactive display 142.

At step 210, the one or more potential customer user 102 determines whether to continue with process 200. This determination may be substantially based on whether the displayed offer for utility products and/or service is desirable. If the determination is in the affirmative, process 200 proceeds to step 212; if the determination is negative, process 200 proceeds to step 232.

At step 212, relevant customer information is received from the one or more potential customer user 102 by presenting the one or more potential customer user 102 with one or more forms via at least one computing device 104 and/or interactive display 142 that may be completed using one or more input devices configured to facilitate human interaction with at least one computing device 104 and/or interactive display 142. By way of example and not limitation, relevant information may include the one or more potential customer user's 102 name, address at which to receive utility products and/or services, preferred date at which to begin receiving utility products and/or services, phone number, email address birthdate, account number (if applicable), and the like.

At step 214, a unique identifier 511 (not shown in FIG. 2) is generated for the one or more customer user 102 to go with the newly created account. In some non-limiting exemplary embodiments, the generation of unique identifier 511 may be performed in an at least partially automatic manner once the relevant customer information is received by system 100 at step 212. By way of example and not limitation, unique identifier 511 may comprise a pictorial or text based form, such as a barcode, QR code, SnapCode, account number, or any similar format as may be apparent to those skilled in the relevant arts after reading the description herein, and may be used to quickly and efficiently identify the account for the one or more customer user 102. In some aspects, unique identifier 511 may be randomly generated by system 100 and/or may be generated by system 100 in accordance with one or more algorithms. Unique identifier 511 may be provided to the one or more customer user 102 via at least one computing device 104. In some additional aspects, unique identifier 511 may be printed.

At step 216, the one or more customer user 102 decides whether to pay with cash 402 (not shown in FIG. 2). If the one or more customer user 102 decides not to pay with cash 402, process 200 proceeds to step 218. If the one or more customer user 102 decides to pay with cash 402, process 200 proceeds to step 226. The decision of the one or more customer user 102 may be indicated, by way of example and not limitation, by making a selection via a check box 507 (not shown in FIG. 2) or radio button 505 (not shown in FIG. 2) displayed upon at least one computing device 104 and/or interactive display 142 using one or more input devices that may be associated therewith.

At step 218, the one or more customer user 102 is presented with a request for payment information via at least one computing device 104 and/or interactive display 142. In some non-limiting exemplary embodiments, the request for payment may be triggered in an at least partially automatic manner once system 100 receives an indication that the one or more customer user 102 has decided not to pay with cash 402. By way of example and not limitation, the request may be presented via one or more forms displayed via at least one computing device 104 and/or interactive display 142 that may be completed by the one or more customer user 102.

At step 220, payment information is received from the one or more customer user 102 via at least one computing device 104 and/or interactive display 142. In some non-limiting exemplary embodiments, this may be accomplished when the one or more customer user 102 completes one or more form presented at step 218 using one or more input devices configured to facilitate human interaction with at least one computing device 104 and/or interactive display 142. Payment information may include, by way of example and not limitation, credit/debit card information or automated clearing house (ACH) payment information.

At step 222, the account for the one or more customer user 102 is credited for an amount equal to the received payment (less any applicable fees). This may be accomplished contemporaneously to receiving the required payment information when system 100 executes the necessary credit/debit card or ACH transaction. In some aspects, the account for the one or more customer user 102 may also be activated in the system of record of the relevant product and/or service provider(s) 146 and system 100 may register the relationship between the one or more customer user 102 and relevant product and/or service provider(s) 146 with any regulatory agencies as required. In some non-limiting exemplary embodiments, one or more elements of step 222 may be performed in an at least partially automatic manner.

At step 224, a notification is sent to the relevant product and/or service provider(s) 146 to activate/turn on/provide one or more product and/or service. In some aspects, this may occur in an at least partially automatic manner. If a preferred start date was specified, products and/or services may be scheduled to start at that time, with the scheduling action being performed in at least partially automatic fashion in some instances. If no start date was specified or if the preferred start date is not feasible, an alternative start date may be used. In some non-limiting exemplary embodiments, the alternative start date may be suggested and/or accepted by system 100 in an at least partially automatic manner as system 100 references one or more scheduling calendars and queries and/or manipulates the information they contain. In some aspects, the one or more scheduling calendar may be created and/or maintained by product and/or service provider 146 and stored in one or more databases such as, by way of example and not limitation, account database 124.

At step 226, the one or more customer user 102 is presented with a request to proceed to a POS terminal 136 (not shown in FIG. 2) at or within physical location 134. By way of example and not limitation, the request may be displayed upon at least one computing device 104 and/or interactive display 142. By way of further example and not limitation, POS terminal 136 may comprise a cash register, credit card reader, or similar payment processing device. In some non-limiting exemplary embodiments, unique identifier 511 for the one or more customer user 102 may also be presented upon a display screen communicatively connected, either wirelessly or via wired connectivity, to at least one computing device 104. The at least one computing device 104 may additionally or alternatively receive unique identifier 511 via an email, text, or SMS message. In some non-limiting exemplary embodiments, one or more elements of step 226 may be performed in an at least partially automatic manner.

At step 228, confirmation of payment to the third party that owns/operates/manages physical location 134 is received from at least one third party representative 138 (not shown in FIG. 2) when third party representative 138 (such as, by way of example and not limitation, a cashier) receives a cash payment from the one or more customer user 102 and inputs the payment amount into POS terminal 136 and scans or otherwise inputs unique identifier 511 for the one or more customer user 102 using a scanning device 404 (not shown in FIG. 2) or other appropriate input device configured to input at least one textual, pictorial, or other similar element into POS terminal 136, thereby allowing POS terminal 136 to receive unique identifier 511 in order to quickly and efficiently match the received payment with the account for the one or more customer user 102. The payment confirmation may be sent electronically to the relevant product and/or service provider(s) 146, such as, by way of example and not limitation, via email. In some additional aspects, a text, SMS, email, or similar notification may also be sent to the at least one computing device 104 to give the one or more customer user 102 a notice of payment confirmation and account activation. Included in that notification or provided in a later notification may also be a link to download a mobile application that the one or more customer user 102 may use to track usage of products and/or services, monitor account balances, and make future payments, including future cash payments using the same unique identifier 511, which may be stored in the mobile application for convenience. Regardless of whether the one or more customer user 102 uses the mobile application, system 100 may be configured to send text, SMS, email, or similar notifications via the at least one computing device 104 when the account balance is determined, such as by one or more human users 102 and/or one or more components of system 100, to be at a level considered to be “low” and/or drops to or below a predetermined value (such as, for example and not limitation, $10.00). Unique identifier 511 for the one or more customer user 102 may, in some instances, be sent along with the low account balance notification to make adding payment funds to the account more convenient. In some non-limiting exemplary embodiments, one or more elements of step 228 may be performed by one or more components of system 100 in an at least partially automatic manner.

At step 230, the appropriate funds are electronically disbursed from the third party that owns/operates/manages physical location 134 to the relevant product and/or service provider(s) 146. Typically, an appropriate amount of funds may comprise the amount customer user paid less any fees charged by the third party that owns/operates/maintains physical location 134 and/or charged by any payment processors. The disbursed funds may be matched to the account for the one or more customer user 102 using the scanned unique identifier 511. In some aspects, one or more components of system 100 may perform step 230 in at least partially automatic manner.

At step 232 process 200 is terminated and process 200 ends.

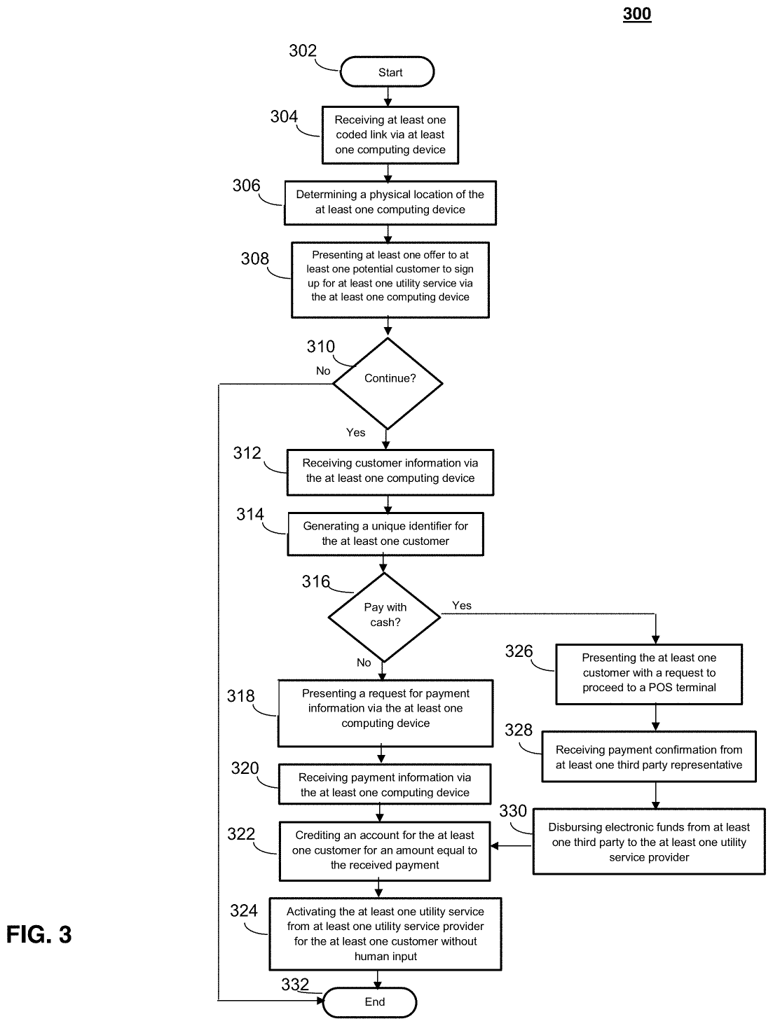

Referring now to FIG. 3, a flowchart illustrating an exemplary process 300 for procuring at least one customer for at least one utility service and initiating delivery of the at least one utility service to the at least one customer, according to an aspect of the present disclosure, is shown.

Process 300, which may at least partially execute within system 100 (not shown in FIG. 3), begins at step 302 with control passing immediately to step 304.

At step 304, at least one coded link 501 (not shown in FIG. 3) is received by at least one user computing device 104 (not shown in FIG. 3). In some aspects, coded link 501 may be provided by at least one interactive display 142 (not shown in FIG. 3), which may be configured at or within at least one physical location 134 (not shown in FIG. 3) that is owned, operated, and/or maintained by at least one third party. By way of example and not limitation, coded link 501 may comprise a QR code, a barcode, a SnapCode, a potential account number, a password, or any similar pictorial and/or textual content as may be apparent to those skilled in the relevant arts after reading the description herein. In some non-limiting exemplary embodiments, coded link 501 may be actively input into at least one computing device 104 by at least one potential customer user 102, such as, for example and not limitation, by scanning coded link 501 with a camera or by manually entering coded link 501 using a touchscreen and a graphical user interface displayed via at least one computing device 104 and/or interactive display 142. In some additional non-limiting exemplary embodiments, coded link 501 may be automatically sent to at least one computing device 104 while requiring only little or no action on the part of the one or more potential customer user 102, such as, for example and not limitation, by being sent via a Wi-Fi signal, via a Bluetooth® connection between interactive display 142 and at least one computing device 104 or by being transmitted via NFC, RFID, or beacon technology in order to obtain the attention of the one or more potential customer user 102 in a more proactive manner. In still some additional aspects, the link may not be coded at all, but rather the one or more potential customer user 102 may actively enter a website address or log into a software application.

At step 306, a physical location is determined for the at least one computing device 104 (and also for the one or more potential customer user 102) and/or interactive display 142. In some non-limiting exemplary embodiments, system 100, or any component or components thereof, may determine the physical location in an at least partially automatic fashion. In some aspects, system 100 may accomplish this by accessing and using location metadata linked to the at least one coded link 501 utilized at step 304. By way of example and not limitation, the metadata may include information regarding the physical location 134 at which the interactive display 142 is located that is being utilized by the one or more potential customer user 102. In some additional aspects, the one or more potential customer user 102 may enter location information manually (such as, for example and not limitation, a zip code for a proposed address at which to receive one or more utility services) by using one or more input devices configured to facilitate human interaction with the at least one computing device 104 and/or interactive display 142, such as a keypad, keyboard, touchscreen, mouse, joystick, microphone, and the like. This information may be used to deliver customized messages, offers, and/or instructions to the one or more potential customer user 102 in order to increase the likelihood of obtaining a response from the one or more potential customer user 102. In yet some additional aspects, location information for the one or more potential customer user 102 may be obtained by getting permission from the one or more potential customer user 102 to access and use the GPS data within the at least one computing device 104. As will be appreciated by those skilled in the relevant arts after reading the description herein, other appropriate methods for determining the physical location of the at least one computing device 104 and/or interactive display 142 may be used without departing from the scope of the present disclosure.

At step 308, at least one offer is presented to the one or more potential customer user 102 to sign up for at least one utility service via at least one computing device 104 and/or interactive display 142. In some non-limiting exemplary embodiments, the offer may be presented in an at least partially automatic fashion as a response triggered by the physical location determination accomplished by system 100 at step 306. In some aspects, the offer may comprise an offer to sign up for, purchase, and receive at least one utility service form at least one product and/or service provider 146 (not shown in FIG. 3). By way of example and not limitation, the offer may be displayed upon at least one display screen or monitor communicatively connected, either wirelessly or via wired connectivity, to at least one computing device 104 and/or interactive display 142.

At step 310, the one or more potential customer user 102 determines whether to continue with process 300. This determination may be substantially based on whether the displayed offer for products and/or services is desirable. If the determination is in the affirmative, process 300 proceeds to step 312; if the determination is negative, process 300 proceeds to step 332.

At step 312, relevant customer information is received from the one or more potential customer user 102 by presenting the one or more potential customer user 102 with one or more forms via at least one computing device 104 and/or interactive display 142 that may be completed using one or more input devices configured to facilitate human interaction with at least one computing device 104 and/or interactive display 142. By way of example and not limitation, relevant information may include the one or more potential customer user's 102 name, service address at which to receive the products and/or services, preferred date at which to begin receiving the products and/or services, phone number, email address birthdate, account number (if applicable), and the like.

At step 314, a unique identifier 511 (not shown in FIG. 3) is generated for the one or more customer user 102 to go with the newly created account. In some non-limiting exemplary embodiments, the generation of unique identifier 511 may be performed in an at least partially automatic manner once the relevant customer information is received by system 100 at step 312. By way of example and not limitation, unique identifier 511 may comprise a pictorial or text based form, such as a barcode, QR code, SnapCode, account number, or any similar format as may be apparent to those skilled in the relevant arts after reading the description herein, and may be used to quickly and efficiently identify the account for the one or more customer user 102. In some aspects, unique identifier 511 may be randomly generated by system 100 and/or may be generated by system 100 in accordance with one or more algorithms. Unique identifier 511 may be provided to the one or more customer user 102 via at least one computing device 104. In some additional aspects, unique identifier 511 may be printed.

At step 316, the one or more customer user 102 decides whether to pay with cash 402 (not shown in FIG. 3). If the one or more customer user 102 decides not to pay with cash 402, process 300 proceeds to step 318. If the one or more customer user 102 decides to pay with cash 402, process 300 proceeds to step 328. The decision of the one or more customer user 102 may be indicated, by way of example and not limitation, by making a selection via a check box 507 (not shown in FIG. 3) or radio button 505 (not shown in FIG. 3) displayed upon at least one computing device 104 and/or interactive display 142 using one or more input devices that may be associated therewith.

At step 318, the one or more customer user 102 is presented with a request for payment information via at least one computing device 104 and/or interactive display 142. In some non-limiting exemplary embodiments, the request for payment may be triggered in an at least partially automatic manner once system 100 receives an indication that the one or more customer user 102 has decided not to pay with cash 402. By way of example and not limitation, the request may be presented via one or more forms displayed via at least one computing device 104 and/or interactive display 142 that may be completed by the one or more customer user 102.

At step 320, payment information is received from the one or more customer user 102 via at least one computing device 104 and/or interactive display 142. In some non-limiting exemplary embodiments, this may be accomplished when the one or more customer user 102 completes one or more forms presented at step 318 using one or more input devices configured to facilitate human interaction with at least one computing device 104 and/or interactive display 142. Payment information may include, by way of example and not limitation, credit/debit card information or automated clearing house (ACH) payment information.

At step 322, the account for the one or more customer user 102 is credited for an amount equal to the received payment (less any applicable fees). This may be accomplished contemporaneously to receiving the required payment information when system 100 executes the necessary credit/debit card or ACH transaction. In some aspects, the account for the one or more customer user 102 may also be activated in the system of record of the relevant product and/or service provider(s) 146 and system 100 may register the relationship between the one or more customer user 102 and relevant product and/or service provider(s) 146 with any regulatory agencies as required. In some non-limiting exemplary embodiments, one or more elements of step 322 may be performed in an at least partially automatic manner.

At step 324, the products and/or services are autonomously activated by the relevant product and/or service provider or providers with no human input at at least one customer location, such as a residential (e.g., house, condominium, etc.) or commercial (e.g., business, industrial location, etc.) location for the one or more customer user 102. If a preferred start date was specified, products and/or services may be started at that time; if no start date was specified or if the preferred date is not feasible, then an alternative start date may be used.

At step 326, the one or more customer user 102 is presented with a request to proceed to a POS terminal 136 (not shown in FIG. 3) at or within physical location 134. By way of example and not limitation, the request may be displayed upon at least one computing device 104 and/or interactive display 142. By way of further example and not limitation, POS terminal 136 may comprise a cash register, credit card reader, or similar payment processing device. In some non-limiting exemplary embodiments, unique identifier 511 for the one or more customer user 102 may also be presented upon a display screen communicatively connected, either wirelessly or via wired connectivity, to at least one computing device 104. The at least one computing device 104 may additionally or alternatively receive unique identifier 511 via an email, text, or SMS message. In some non-limiting exemplary embodiments, one or more elements of step 326 may be performed in an at least partially automatic manner.

At step 328, confirmation of payment to the third party that owns/operates/manages physical location 134 is received from at least one third party representative 138 (not shown in FIG. 3) when third party representative 138 (such as, by way of example and not limitation, a cashier) receives a cash payment from the one or more customer user 102 and inputs the payment amount into POS terminal 136 and scans or otherwise inputs unique identifier 511 for the one or more customer user 102 using a scanning device 404 (not shown in FIG. 3) or other appropriate input device configured to input at least one textual, pictorial, or other similar element into POS terminal 136, thereby allowing POS terminal 136 to receive unique identifier 511 in order to quickly and efficiently match the received payment with the account for the one or more customer user 102. The payment confirmation may be sent electronically to the relevant product and/or service provider(s) 146, such as, by way of example and not limitation, via email. In some additional aspects, a text, SMS, email, or similar notification may also be sent to at least one computing device 104 to give the one or more customer user 102 a notice of payment confirmation and account activation. Included in that notification or provided in a later notification may also be a link to download a mobile application that the one or more customer user 102 may use to track products and/or services usage, monitor account balances, and make future payments, including future cash payments using the same unique identifier 511, which may be stored in the mobile application for convenience. Regardless of whether the one or more customer user 102 uses the mobile application, system 100 may be configured to send text, SMS, email, or similar notifications via at least one computing device 104 when the account balance is determined, such as by one or more human users 102 and/or one or more components of system 100, to be at a level considered to be “low” and/or drops to or below a predetermined value (such as, for example and not limitation, $10.00). Unique identifier 511 for the one or more customer user 102 may, in some instances, be sent along with the low account balance notification to make adding payment funds to the account more convenient. In some non-limiting exemplary embodiments, one or more elements of step 328 may be performed by one or more components of system 100 in an at least partially automatic manner.

At step 330, the appropriate funds are electronically disbursed from the third party that owns/operates/manages physical location 134 to the relevant product and/or service provider(s) 146. Typically, an appropriate amount of funds may comprise the amount customer user paid less any fees charged by the third party that owns/operates/maintains physical location 134 and/or charged by any payment processors. The disbursed funds may be matched to the account for the one or more customer user 102 using the scanned unique identifier 511. In some aspects, one or more components of system 100 may perform step 330 in at least partially automatic manner.

At step 332 process 300 is terminated and process 300 ends.

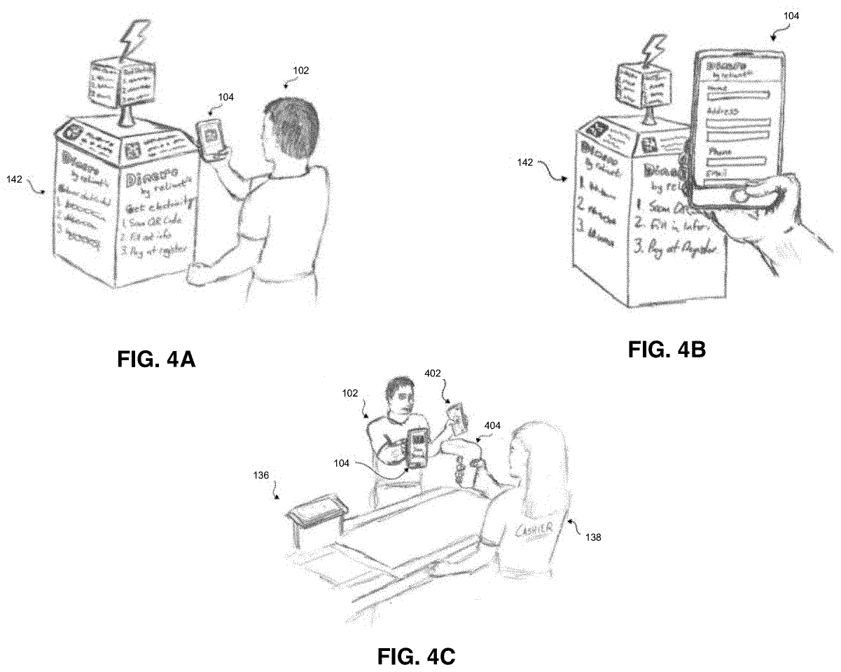

Referring now to FIGS. 4A-4C, images of a customer using an exemplary mobile computing device 104 to interact with an exemplary interactive display 142 in order to facilitate cash payment for at least one utility service, according one or more aspects of the present disclosure, are shown.

In some aspects, interactive display 142 may comprise a three dimensional cardboard display, similar to the one shown in FIGS. 4A-4B. In such aspects, interactive display 142 may display a QR code, barcode, SnapCode, or similar image that one or more potential customer users 102 may scan using a camera and an associated camera application or QR reader integrated with and/or communicatively coupled, either wirelessly or via wired connectivity, to at least one computing device 104. By scanning the code, the camera application or QR reader of the at least one computing device 104 may automatically display a URL link that potential customer may tap, click, or otherwise select using one or more input devices, such as a touchscreen, in order to be directed to a site with one or more web forms to complete to sign up to receive one or more utility services, such as, by way of example and not limitation, electricity and/or natural gas. Alternatively, the one or more potential customer user 102 may choose to manually enter a URL displayed upon interactive display 142 into a web browser that may be accessible using at least one computing device 104. Once the one or more potential customer user 102 completes the one or more web forms, the one or more customer user 102 may receive a unique identifier 511 (not shown in FIGS. 4A-4C) (e.g., a barcode, etc.), either automatically or via text or SMS message, and the one or more customer user 102 may then be directed to a POS terminal 136 at or with the same physical location 134 where interactive display 142 is configured in order to pay for the products and/or services. The one or more customer user 102 may then use cash 402 to prepay for a desired amount of products and/or services at a predetermined start date. Cash 402 may be received by a third party representative 138 (e.g., a cashier) on behalf of the third party that owns/operates/maintains the physical location 134. Upon receiving cash 402, third party representative 138 may use a scanning device 404 configured to input at least one textual, pictorial, or other similar element into POS terminal 136 in order to facilitate an electronic process that activates the utility service account for the one or more customer user 102 and credits the account for the amount paid, less any fees, as described above.

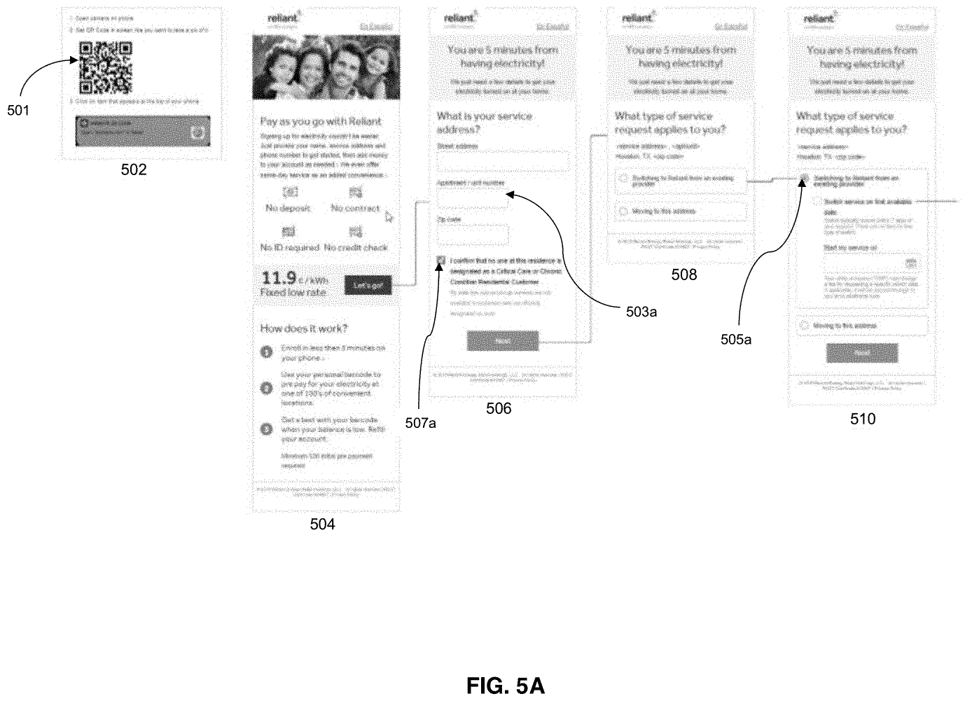

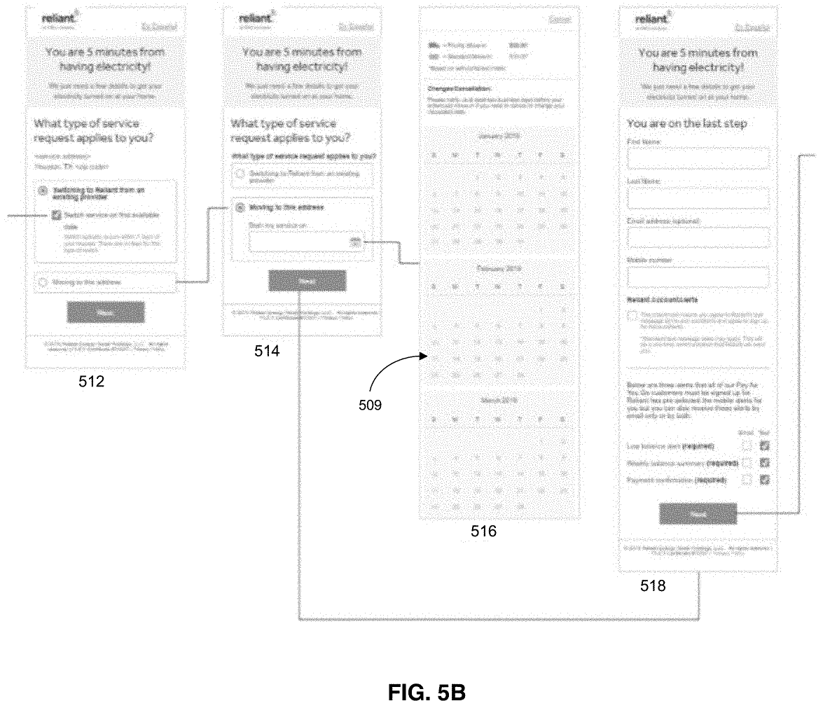

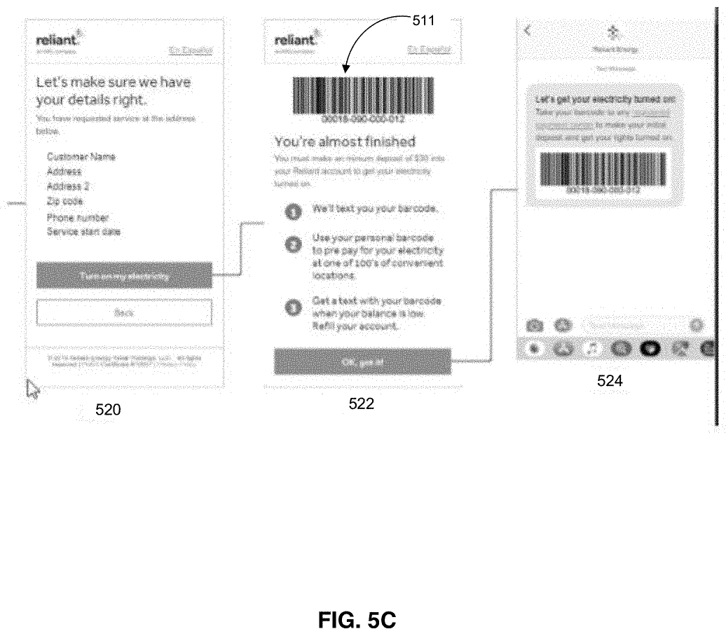

Referring now to FIGS. 5A-5C, images of various exemplary screenshots that may be presented upon a mobile computing device 104 to at least one prospective customer for at least one utility service, according to one or more aspects of the present disclosure, are shown.

Each exemplary screenshot may represent a graphical user interface that may be displayed in the form of a screen presented upon a monitor, touchscreen, projector, or similar display device communicatively coupled, either wirelessly or via wired connectivity, to one or more computing devices 104. As will be apparent to those skilled in the relevant arts after reading the description herein, other information and/or content may be displayed upon the exemplary screenshots as needed or desired, and all of the elements depicted in these exemplary screenshots are optional.

Exemplary screen 502 depicts an exemplary scanned coded link 501 (a QR code is shown in FIG. 5A as an example) that may correspond to at least one URL link. Exemplary screen 504 gives general information about a utility service plan. Exemplary screens 506-518 represent various pages of an exemplary web form that may be filled out by one or more potential customer user 102 (not shown in FIGS. 5A-5C) in order to sign up to receive one or more utility services. For example, screen 506 contains multiple text fields 503 (labeled only as text field 503a in FIG. 5A, for clarity) wherein potential customer user may input address information. Screens 508-514 comprise several radio buttons 505 (labeled only as radio button 505a in FIG. 5A, for clarity) and check boxes 507 (labeled only as check box 507a in FIG. 5A, for clarity) that may be selected in order to choose various options. Exemplary screen 516 depicts an exemplary interactive calendar 509 for selecting, in this case, a utility service (e.g., electricity, natural gas, etc.) start date. Exemplary screen 520 depicts an exemplary information review screen, while screen 522 shows an exemplary unique identifier 511 in the form of a barcode. Exemplary screen 524 shows the unique identifier 511 having been sent as an SMS message.

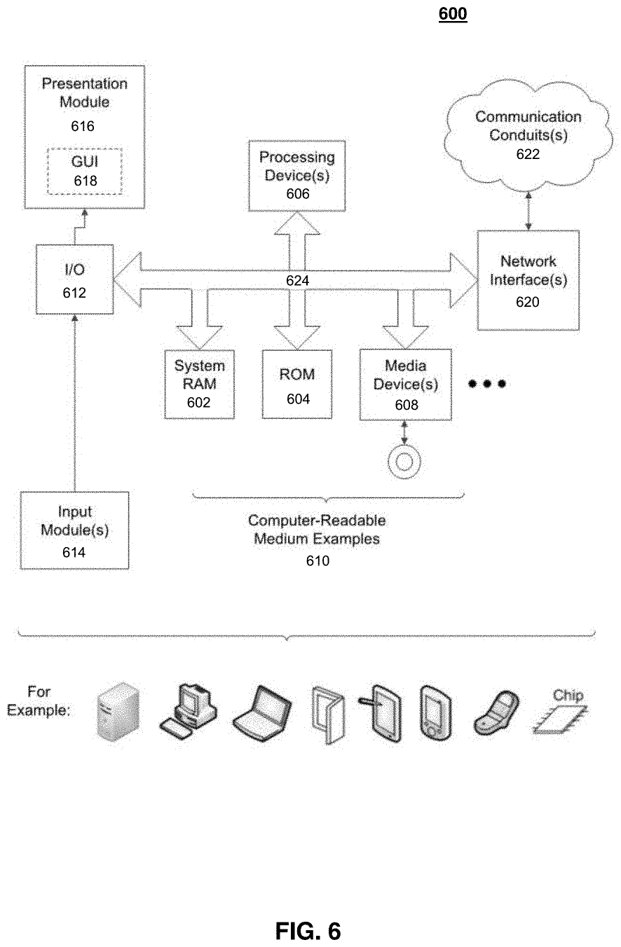

Referring now to FIG. 6, a block diagram of an exemplary computing system 600 useful for implementing one or more aspects of the present disclosure is shown.

FIG. 6 sets forth illustrative computing functionality 600 that may be used to implement the one or more web servers 120, one or more application servers 122, one or more gateways 108-118, account database 124, third party database 126, billing/invoice database 128, payment database 130, usage database 132, at least one computing devices 104 and/or interactive display 142 utilized by one or more users 102 to access Internet 106, POS terminal 136 utilized by third party representative 138 to access internet 106, or any other component of system 100. In all cases, computing functionality 600 represents one or more physical and tangible processing mechanisms.

Computing functionality 600 may comprise volatile and non-volatile memory, such as RAM 602 and ROM 604, as well as one or more processing devices 606 (e.g., one or more central processing units (CPUs), one or more graphical processing units (GPUs), and the like). Computing functionality 600 also optionally comprises various media devices 608, such as a hard disk module, an optical disk module, and so forth. Computing functionality 600 may perform various operations identified when the one or more processing devices 606 execute instructions that are maintained by memory (e.g., RAM 602, ROM 604, and the like).

More generally, instructions and other information may be stored on any computer readable medium 610. The term “computer readable medium” refers to any storage and/or transmission medium that participates in providing instructions to a processor for execution. Such a medium is commonly tangible and non-transient and can take many forms, including but not limited to non-volatile media, volatile media, and transmission media. A computer readable medium 610 includes but is not limited to, static memory storage devices, magnetic storage devices, and optical storage devices. The term “computer readable medium” also encompasses plural storage devices. In all cases, computer readable medium 610 represents some form of physical and tangible entity. By way of example and not limitation, computer readable medium 610 may comprise “computer readable media,” “computer storage media” and “communications media.” When the computer readable media is configured as a database, the database may be any type of database.

“Computer storage media” comprises volatile and non-volatile, removable and non-removable media implemented in any method or technology for storage of information, such as computer readable instructions, data structures, program modules, or other data. Computer storage media may be, for example, and not limitation, RAM 602, ROM 604, EEPROM, Flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as wired network or direct-wired connection, and wireless media such as acoustic, RF, infrared, and other wireless media. Combinations of any of the above are also included within the scope of computer readable medium.

Computing functionality 600 may also comprise an input/output module 612 for receiving various inputs (via input modules 614), and for providing various outputs (via one or more output modules). One particular output module mechanism may be a presentation module 616 and an associated GUI 618. Computing functionality 600 may also include one or more network interfaces 620 for exchanging data with other devices via one or more communication conduits 622. In some aspects, one or more communication buses 624 communicatively couple the above-described components together.

The one or more communication conduits 622 may be implemented in any manner (e.g., by a local area network, a wide area network (e.g., the Internet), and the like, or any combination thereof). Additionally, the one or more communication conduits 622 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The terms “module” and “component” as used herein refers to any hardware, software, firmware, artificial intelligence, fuzzy logic, or combination of these that is capable of performing the functionality associated with that element. The terms “module” and “component” may generally represent software, firmware, hardware, or any combination thereof. In the case of a software implementation, the module or component represents program instructions or code that performs specified tasks when executed by one or more processors. The program code may be stored in one or more computer readable memory devices, as described with reference to FIG. 6. The features of the present disclosure described herein are platform-independent, meaning the techniques can be implemented on a variety of commercial computing platforms having a variety of processors (e.g., desktop, laptop, notebook, tablet computer, personal digital assistant (PDA), mobile telephone, smart telephone, gaming console, and the like).

The term “server” as used herein is a computational system (e.g., having both software and suitable computer hardware) to respond to requests across a computer network to provide, or assist in providing, a network service. Servers can run on a dedicated computer, and many networked computers are capable of hosting servers. In many cases, a computer can provide several services and have several servers running. Servers commonly operate within a client-server architecture, in which servers are computer programs running to serve the requests of other programs, namely the clients. The clients typically connect to the server through the network but may run on the same computer. In the context of Internet Protocol networking, a server is often a program that operates as a socket listener. An alternative model, the peer-to-peer networking model, enables all computers to act as either a server or client, as needed. Servers often provide essential services across a network, either to private users (e.g., inside a large organization) or to public users (e.g., via the Internet).

In view of the above, a non-transitory processor readable storage medium is provided. The storage medium comprises an executable computer program product that further comprises a computer software code that, when executed on a processor, causes the processor to perform certain steps or processes. Such steps may include, but are not limited to, causing the processor to receive at least one coded link 501, present an offer to sign up for at least one utility service, receive information about at least one potential customer user 102, and generate a unique identifier 511 for the at least one customer.

It is noted that the order of the steps of processes described herein, including the starting points thereof, may be altered without departing from the scope of the present disclosure. Thus, steps may be added or removed so that there are more or less steps present. In addition, the order of the steps may be changed without departing from the scope of the disclosure, as will be appreciated by those skilled in the relevant arts after reading the description herein.

The figures described herein are illustrative embodiments of the disclosure and are non-limiting descriptions. For example, the methods and systems of FIGS. 1-3 can include interacting with users to obtain data such as account information, payment information, etc. In various embodiments, the display may be only a visual display that does not interact with the user (e.g., the user uses a computing device to access/provide information based on information obtained from the display). Thus, a user may access a display at a first physical location to interact with an account (e.g., to obtain or provide account information), and the user may link data to the account (e.g., link payment information to the account information). In various embodiments, the account may correspond to the provision of products and/or services, including utility services. Thus, in some aspects, a customer may use a display to access account information associated with a utility service and link payment information to the account information. This may enable the customer to obtain the utility service.

Various elements described herein may be located at various locations, which may be the same as, or different from, each other. For example, where a display facilitates a user being able to associate a payment made with an account, the display may be at a same location as a location at which the payment is made, or the display may be at a separate location that is distinct from where the payment is made. Events, including payments and other events associated with account information, may occur before, at a same time as, or after a user interacts with a display. Thus, events (including payments and other events associated with account information) may occur before, at a same time as, or after an event associated with an account (e.g., when an account is created, accessed, updated, etc.).

While various aspects of the present disclosure have been described above, it should be understood that they have been presented by way of example and not limitation. It will be apparent to persons skilled in the relevant arts that various changes in form and detail can be made therein without departing from the spirit and scope of the present disclosure. Thus, the present disclosure should not be limited by any of the above described exemplary aspects.

In addition, it should be understood that the figures in the attachments, which highlight illustrative structure, methodology, functionality, and advantages of the present disclosure, are presented for example purposes only. The present disclosure is sufficiently flexible and configurable, such that it may be implemented in ways other than that shown in the accompanying figures (e.g., implementation within computing devices and environments as well as physical locations other than those mentioned herein). As will be appreciated by those skilled in the relevant arts after reading the description herein, certain features from different aspects of the systems, methods and computer program products of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant arts who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A method for procuring at least one customer for at least one utility service, the method comprising:
receiving, via at least one computing device, at least one coded link;
presenting, via the at least one computing device, an offer to sign up for the at least one utility service at a physical location associated with at least one third party;
receiving, via the at least one computing device, information about the at least one customer; and
generating, via the at least one computing device, a unique identifier for the at least one customer.

2. The method of claim 1, further comprising:
receiving, via the at least one computing device, an indication that the at least one customer wants to use cash to pay for the at least one utility service; and
receiving, via the at least one computing device, confirmation that a cash payment was made for the at least one utility service to the at least one third party; wherein the unique identifier is received by at least one point of sale terminal contemporaneous to the cash payment being made.

3. The method of claim 2, further comprising:
disbursing, via the at least one computing device, electronic funds from the at least one third party to at least one utility service provider; and
crediting, via the at least one computing device, an account for the at least one customer with an amount equal to the cash payment;
wherein the unique identifier matches the cash payment to the account for the at least one customer.

4. The method of claim 2, wherein the unique identifier comprises at least one of: a barcode and a QR code.

5. The method of claim 4, wherein the unique identifier is received by the at least one point of sale terminal by being scanned by at least one scanning device.

6. The method of claim 1, wherein the at least one coded link is provided by at least one interactive display.

7. The method of claim 6, wherein the at least one interactive display comprises at least one of: a poster, a cardboard stand-alone display, an electronic display, and a kiosk.

8. The method of claim 1, wherein the at least one coded link is received by the at least one computing device via at least one of: beacon technology, near field communication, a Wi-Fi connection, Bluetooth®, and radio-frequency identification.

9. The method of claim 1, further comprising:
activating, via the at least one computing device, at least one utility service at at least one customer location.

10. The method of claim 9, wherein the at least one customer location comprises at least one of: a residential location and a commercial location.

11. The method of claim 9, wherein the activating occurs automatically.

12. The method of claim 1, further comprising:
determining, via the at least one computing device, a physical location for the at least one customer.

13. The method of claim 12, wherein the physical location of the at least one customer is determined from information in the metadata of the coded link.

14. The method of claim 12, wherein the physical location of the at least one customer is determined from GPS data within the at least one computing device.

15. A system comprising:
a server comprising a microprocessor;
one or more computer storage media having stored thereon instructions that facilitate the procurement of at least one customer for at least one utility service when executed by one or more processors of at least one computing device, causing the one or more processors to:
receive, via the at least one computing device, at least one coded link;
present, via the at least one computing device, an offer to sign up for the at least one utility service at a physical location associated with at least one third party;
receive, via the at least one computing device, information about the at least one customer; and
generate, via the at least one computing device, a unique identifier for the at least one customer.

16. One or more processors as recited in claim 15, wherein the instructions further cause the one or more processors to:
receive, via the at least one computing device, an indication that the at least one customer wants to use cash to pay for the at least one utility service; and
receive, via the at least one computing device, confirmation that a cash payment was made for the at least one utility service to the at least one third party;
wherein the unique identifier is received by at least one point of sale terminal contemporaneous to the cash payment being made.

17. One or more processors as recited in claim 16, wherein the instructions further cause the one or more processors to:
disburse, via the at least one computing device, electronic funds from the at least one third party to at least one utility service provider; and
credit, via the at least one computing device, an account for the at least one customer with an amount equal to the cash payment;
wherein the unique identifier matches the cash payment to the account for the at least one customer.

18. One or more processors as recited in claim 15, wherein the at least one coded link is provided by at least one interactive display.

19. One or more processors as recited in claim 18, wherein the at least one interactive display comprises at least one of: a poster, a cardboard stand-alone display, an electronic display, and a kiosk.

20. The method of claim 15, wherein the at least one coded link is received by the at least one computing device via at least one of: beacon technology, near field communication, a Wi-Fi connection, Bluetooth®, and radio-frequency identification.
